(19) United States
(12) Patent Application Publication
(10) Pub. No.: US 2012/0131971 A1
(43) Pub. Date: May 31, 2012

(54) Nutrient Delivery with an Aluminosilicate Substrate

(76) Inventors: Robert T. Heaton, Markham (CA); Timothy C. Shoniker, Greenwood (CA)

(21) Appl. No.: 13/245,779

(22) Filed: Sep. 26, 2011

Related U.S. Application Data
(60) Provisional application No. 61/386,467, filed on Sep. 24, 2010.

(51) Int. Cl. C05G 1/00

(52) U.S. Cl. 71/29

(57) ABSTRACT

Plant nutrients are captured by means of cation exchange and are rendered water insoluble and held indefinitely by electrostatic ionic attraction within the confines of the delivery medium, to wit: zeolites substrate. These nutrients are released or accessible upon plant demand, minimizing leaching into surrounding soil or groundwater. A delivery method provides a naturally occurring zeolites substrate. The substrate possesses a valence charge of minus 2 (−2). The substrate is doped with one or a number of chemical agents that through natural cationic exchange allow the substrate to encapsulate and hold by means of electrostatic ionic attraction one or a number of nutrient elements or compounds.

### PRIORITY CLAIM

The present application claims benefit of U.S. provisional patent application No. 61/386,467 filed on Sep. 24, 2010 by Timothy C. Shoniker and Robert T. Heaton.

### BACKGROUND OF THE INVENTION

(a) Field of the Invention

The present invention relates to nutrient delivery to plant and, particularly, to solid chemical compositions, ionic binder system, and improved delivery process for release of fertilizer nutrients upon plant demand, and bioremediation or phytoremediation of soil.

(b) Description of the Related Art

Zeolites are part of the aluminosilicate family and are naturally occurring volcanic minerals that were formed when volcanic ash was deposited in ancient alkaline lakes. The reaction between the volcanic ash and the salts in the lake water altered the ash into the unique tetrahedral crystalline structures that we now know as zeolites. Zeolites were originally discovered in 1756, when a Swedish mineralogist Axel Fredrick Cronstedt discovered that stilbite, a naturally occurring mineral visibly lost water when heated, and he named the class of minerals as “zeolites” from the classical Greek word meaning “boiling stones”.

The unique tetrahedral crystalline structure of zeolites contain a very large number of small channels that typically measure between 3.5 and 7 Ångström units (3.5-7 Å) equivalent to 3.5-7 ten-billionths of a metre—quite small. Zeolites are often referred to as “nano-porous”, meaning that they possess many pores that are typically measured in nano-meters or several billionths of a metre. This property renders zeolites as a very good molecular sieve and they are now commonly used as an ion-exchange medium/resin in various industries ranging from petro-chemical to water treatment.

Zeolites typically carry a valence charge of minus two (−2), meaning that they naturally, electrostatically attract, encapsulate, and hold cations (positively charged ions) within the lattice structure.

### SUMMARY OF THE INVENTION

This invention discloses a means for the formulation and preparation of solid crystalline chemical compounds, which provide sources of macronutrients, secondary nutrients, micronutrients, electron acceptors and other agents for agriculture, soil bioremediation, and/or phytoremediation that are captured by means of cation exchange and are rendered water insoluble and held indefinitely by electrostatic ionic attraction within the confines of the delivery medium (substrate) and are released or accessible upon plant demand, minimizing leaching into surrounding soil or groundwater.

Further this invention discloses a means to prepare any of the formulations for a number of different application methods for the macronutrient rich substrate, i.e. granular for widespread topical and/or tiller instilled crop and planter use and solid stick for systemic and/or root application.

Moreover the disclosed formulations and production processes utilize an economic approach to introduce these macronutrient ingredients in a particular order to achieve specific macronutrient prescriptions for a wide range of specific applications.

This invention also discloses a delivery method using a substrate that is a naturally occurring mineral compound that possesses a valence charge of minus 2 (−2). The substrate is treated (doped) with one or a number of chemical agents (solutions/granular compounds) that through natural cationic exchange allow the substrate to encapsulate and hold by means of electrostatic ionic attraction one or a number of nutrient elements and/or compounds.

Further, this invention also discloses a unique method of binding the finished granular product to form a solid form using a biodegradable polymer-binding agent via a moulding process for a variety of applications and uses.

### BRIEF DESCRIPTION OF THE DRAWINGS

FIG. 1 is a schematic view of the chemical structure for Urea.

FIG. 2 is a schematic view of the chemical structure for Ammonium Nitrate.

FIG. 3 is a schematic view of the chemical structure for Monopotassium Phosphate.

### DETAILED DESCRIPTION OF THE INVENTION

Referring now to the detailed description, a preferred embodiment of a method is provided for the delivery of macronutrients, secondary, and micronutrients for indoor and outdoor plant life. The “high performance” delivery method delivers nearly all of the inorganic nutrient material to the respective plant or tree. The delivery method is “low leaching”, whereas less than 0.10% nominal of the available inorganic nutrients are a ground water leach threat while being plant accessible upon demand. The delivery method has a “zero” long term environmental impact, whereas the fortification of soil with the product(s) will be beneficial to the environment over the long term. And, the delivery method is “cost effective” to manufacture, whereas the end product(s) are affordable to home hobbyists, horticulture enthusiasts, landscape professionals, and commercial growers alike.

The macronutrient amendment of the Zeolite ore may be performed with organic and/or inorganic material. In a preferred embodiment, the amendment may use a combination of both or simply inorganic macronutrient chemical material.

Although, other natural zeolites, and certainly synthetic zeolites exhibit greater cation exchange ability than the preferred mineral, other properties of the (Clinoptilolite) zeolite make it one of the more suitable zeolites for the purposes discussed and defined herein.

Several zeolite types were examined in detail and considered. Some such as Phillipisite and Chabazite exhibited excellent properties in terms of Cation Exchange Capacity (CEC), however they are either not native to North America or are available at an extreme cost that would render them unsuitable for the purposes discussed herein.

Clinoptilolite is a high quality, high purity type of this natural mineral and is actually registered as fit for human and animal consumption. It is typically surface or placer mined and in North America readily available in large quantities, and reasonably priced.

Intrinsic to clinoptilolite zeolite is a quantity of Potassium (K2) ions usually in the range 3-3.5%. This is one of the major macronutrients essential for plant sustenance & growth. Additionally the clinoptilolite type of zeolite, contains a quantity of plant accessible Calcium (Ca), typically in the range of 1-1.5% These properties combined with the low Sodium (Na) content makes this particular mineral a preferred substrate for the preferred composition.

Urea Ammonium Nitrate 28 Solution (UAN-28)

UAN-28 is an aqueous solution of soluble Urea and Ammonium Nitrate.

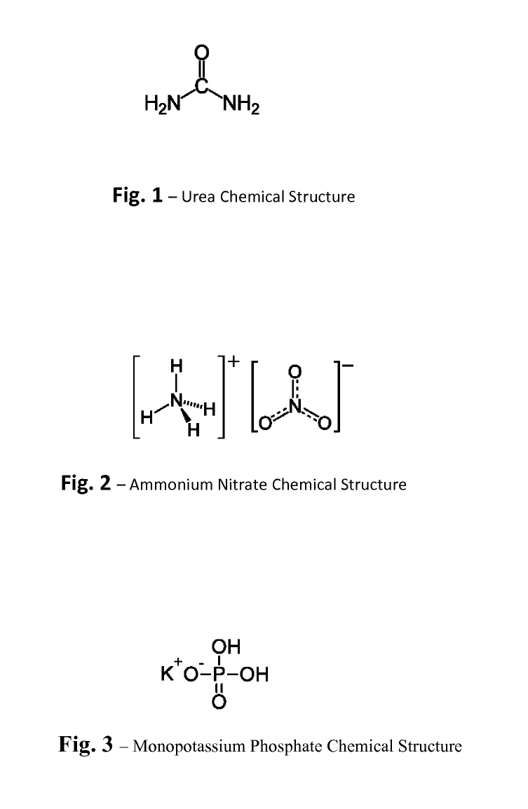

Urea or Carbamide is an organic compound with the chemical formula (NH2)2CO. The molecule has two amine (—NH2) residues joined by a carbonyl (—CO—) function. FIG. 1 shows the Urea chemical structure, and the typical properties of Urea are shown Table 1 below.

TABLE 1
Typical Properties - Urea

| Chemical Formula | (NH₂)₂CO | |
|---|---|---|
| Molar mass | 60.07 | g/mol |
| Density | 1.32 | g/cm³ |
| Solubility in Water | 108 | g/100 ml (20° C.) |

Urea was first discovered in urine in 1773 by the French chemist Hilaire Rouelle and first synthesized in 1828 Germany, when a failed experiment to produce ammonium cyanate the German chemist Friedrich Wöhler obtained urea by treating silver isocyanate with ammonium chloride. The following reaction was observed:

AgNCO+NH₄Cl→(NH₂)₂CO+AgCl

This was the first time an organic compound was artificially synthesized from inorganic starting materials, without the involvement of living organisms. The results of this experiment implicitly discredited “vitalism”: the theory that the chemicals of living organisms are fundamentally different from inanimate matter.

More than 90% of world production of Urea is destined for use as a nitrogen-release fertilizer. Urea has the highest nitrogen content of all solid nitrogenous fertilizers in common use (typically 46.7%). Therefore, it has the lowest transportation costs per unit of nitrogen nutrient.

Ammonuim Nitrate is nitrate of ammonia with the chemical formula NH4NO3. It is a white crystalline solid at room temperature and standard pressure. It is commonly used in agriculture as a high-nitrogen fertilizer, and it has also been used as an oxidizing agent in explosives, including improvised explosive devices. It is an ionic substance. The chemical structure of Ammonium Nitrate is shown in FIG. 2, and the typical properties are shown in Table 2 below.

TABLE 4-2
Typical Properties -Ammonium Nitrate

| Chemical Formula | NH₄NO₃ | |
|---|---|---|
| Molar mass | 80.043 | g/mol |
| Density | 1.725 | g/cm³ (20° C.) |
| Solubility in Water | 150 | g/100 ml (20° C.) |

UAN-28 Solution is the combination of urea and ammonium nitrate and has an extremely low critical relative humidity (18% at 30° C.) and therefore is only practical to be used as liquid fertilizer. For our purposes we chose UAN-28 as it is readily available in large quantities and is relatively inexpensive.

Other grades are UAN 32, UAN 30 and UAN 18. The solutions are quite corrosive towards mild steel (up to 500 MPY on C1010 steel) and are therefore generally equipped with a corrosion inhibitor to protect tanks, pipelines, nozzles, etc. UAN-28 solution is a clear colourless liquid, with little to no detectible ammonia odor.

As shown in Table 3 below, the following are the properties of the UAN-28 Solution used herein.

TABLE 4-3
Properties - UAN-28 Solution

| Chemical | |
|---|---|
| Total Nitrogen, wt. % | 28.0 |
| Free Ammonia, ppm | 500 max. |
| Ammonium Nitrate, wt. % | 37~42 |
| Urea, wt. % | 28~32 |
| Water, wt. % | 29~31 |
| Corrosion Inhibitor, ppm | 150-250 |
| pH | 7.0~7.5 |
| Physical | |
| Specific Gravity @15.5° C. | 1.28 |
| Vapour Pressure, Psia | 0.11 |
| Salt Out Temp., ° C. | −15 |
| Boiling Point, ° C. | >100 |

Monopotassium Phosphate (MKP)

Monopotassium phosphate (also potassium dihydrogen phosphate, KDP, or monobasic potassium phosphate, MKP) —KH2PO4— is a soluble salt which is used as a fertilizer, a food additive and a fungicide. The chemical structure of Monopotassium Phosphate is shown in FIG. 3 of the drawings.

Monopotassium Phosphate is a source of phosphorus and potassium. It is also a buffering agent. When used in fertilizer mixtures with urea and ammonium phosphates, it minimizes escape of ammonia by keeping the pH at a relatively low level. Fertilizer grade MKP contains the equivalent of 52% P2O5 and 34% K2O, and is labeled 0-52-34. MKP is often used as a nutrient source in the greenhouse trade and in hydroponics. It is one of the components of Gatorade (used as both an emulsifier and pH buffer) and is used as an additive in cigarettes. At 400° C. it decomposes, by loss of water, to potassium metaphosphate (KPO3). The properties of Monopotassium Phosphate (MKP) may be measured and set forth in a table like those shown above. Both the chemical and physical characteristics could be measured and set forth in detail.

Mono Ammonium Phosphate (MAP)

Monoammonium phosphate or Ammonium dihydrogen phosphate, NH4H2PO4, is formed when a solution of phosphoric acid is added to ammonia until the solution is distinctly acid. It crystallizes in quadratic prisms. Monoammonium phosphate is often used in the blending of dry agricultural fertilizers. It supplies soil with the elements nitrogen and phosphorus in a form which is usable by plants. The compound is also a component of the ABC powder in some dry chemical fire extinguishers.

An Aqueous solution made from Granular Mono Ammonium Phosphate NH4H2PO4 and Water H2O.

Description of Nutrient Impregnation Methods

The unique cation exchange ability of zeolites, specifically Clinoptilolite from Bear River renders this mineral as a preferred plant macronutrient delivery medium/substrate.

Typically, macronutrient delivery has been in the form of traditional soil fertilization techniques, whereas a large portion 30-50% of the macronutrients delivered using this method are leached into the surrounding groundwater.

Experimental Testing

A great deal of empirical information is available about the raw materials being used for macronutrient amendment, however very little to no data exists regarding the behavior of these materials within the Zeolite lattice be it concerning Zeolite impregnation or macronutrient delivery to plant life.

Cationic, Electrostatic

Critical Relative Humidity—(CRH) of a salt is defined as the relative humidity of the surrounding atmosphere (at a certain temperature) at which the material begins to absorb moisture from the atmosphere and below which it will not absorb atmospheric moisture.

1. A method for delivery of plant nutrients comprising the steps of:
a. providing a substrate with a valence charge;
b. doping the zeolite substrate with a chemical agent and causing a natural cationic exchange;
c. providing plant nutrients impregnated within the zeolite substrate;
d. capturing by electrostatic ionic attraction the plant nutrients within the zeolite substance, whereby the plant nutrients are rendered water insoluable; and
e. releasing plant nutrients from the zeolite substrate to a plant upon demand by the plant.

2. A method for delivery of plant nutrients as in claim 1 in which said substrate in the step of providing a substrate is from a selection of naturally or synthetic zeolite substances.
